(19) United States
(12) Patent Application Publication
(10) Pub. No.: US 2026/0264656 A1
(43) Pub. Date: Sep. 10, 2026

(54) VEHICLE BRAKE SYSTEM WITH MIXED BRAKE TYPES

(71) Applicant: HL MANDO CORPORATION, Gyeonggi-do (KR)

(72) Inventors: Christian ROSS, Auburn, MI (US); Tomy SEBASTIAN, Auburn, MI (US); Raja RAMAKRISHNAN, Auburn, MI (US); Dheerajkumar PATEL, Auburn, MI (US); Lucas RITTER, Auburn, MI (US); Shakil HOSSAIN, Auburn, MI (US); Jonathan KNIEPER, Auburn, MI (US)

(21) Appl. No.: 19/547,428

(22) Filed: Feb. 23, 2026

Related U.S. Application Data
(60) Provisional application No. 63/766,943, filed on Mar. 4, 2025.

(51) Int. Cl. B60T 13/66; B60T 13/74

(52) U.S. Cl. CPC B60T 13/662; B60T 13/745; B60T 13/746; B60T 2270/402

(57) ABSTRACT

A brake system for a vehicle is provided, the brake system includes: two first-type brakes connected to a first set of wheels of the vehicle; two second-type brakes connected to a second set of wheels of the vehicle; and a brake controller assembly configured to control the two first-type brakes and the two second-type brakes. The brake controller assembly includes a backup power source separate from a primary power source of the vehicle and provided within the brake controller assembly. The brake controller assembly is configured to control the two first-type brakes and the two second-type brakes such that, in response to a failure of the primary power source of the vehicle, the two first-type brakes provide braking for the vehicle without using the backup power source and the two second-type brakes provide parking brake application for the vehicle using the backup power source.

### CROSS REFERENCE TO RELATED PATENT APPLICATION(S)

This application claims the benefit of U.S. patent application Ser. No. 63/766,943 filed on Mar. 4, 2025, entitled “FRONT IDB/EBCM AND REAR EMB VEHICLE ARCHITECTURE”, which is all hereby incorporated by reference in its entirety.

### BACKGROUND

Various embodiments of the present disclosure generally relate to a brake system for a vehicle and more particularly to a vehicle brake system with mixed brake types.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock, and electric or brake-by-wire brake systems. For example, in a hydraulic brake system, the hydraulic fluid transfers energy from a brake pedal to a brake pad for slowing down or stopping rotation of a wheel of the vehicle. Electronics control the hydraulic fluid in the hydraulic brake system. In an electric brake system, the application and release of the brake is controlled by an electric caliper or motor via an electrical signal.

These electric brake systems typically include an electro-mechanical actuator connected to a brake caliper either by a cable, as the drum in head, or directly attached to the brake caliper. The actuator converts electrical power to rotational mechanical output power for moving the cable or drive screw and applying the brakes. Generally, the electro-mechanical actuator includes an electric motor and a mechanical assembly for achieving the necessary load transfer.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake system for a vehicle may comprise: two first-type brakes connected to a first set of wheels of the vehicle; two second-type brakes connected to a second set of wheels of the vehicle; and a brake controller assembly configured to control the two first-type brakes and the two second-type brakes, the brake controller assembly comprising a backup power source separate from a primary power source of the vehicle and provided within the brake controller assembly, wherein the brake controller assembly is configured to control the two first-type brakes and the two second-type brakes such that, in response to a failure of the primary power source of the vehicle, the two first-type brakes provide braking for the vehicle without using the backup power source and the two second-type brakes provide parking brake application for the vehicle using the backup power source.

The vehicle comprises two front wheels and two rear wheels, the two first-type brakes are integrated dynamic brakes (IDBs) and the first set of wheels is the two front wheels, and the two second-type brakes are electromechanical brakes (EMBs) and the second set of wheels is the two rear wheels.

The brake controller assembly is configured to control the two first-type brakes such that, in response to the failure of the primary power source of the vehicle, the braking of the vehicle is provided solely by the two first-type brakes using a hydraulic system of the vehicle that connects a brake pedal of the vehicle with the brake controller assembly and the two first-type brakes.

The parking brake application is provided using an electromechanical parking pawl of the EMBs.

The brake controller assembly comprises an Electronic Brake Control Module (EBCM) and the EBCM is a 2-channel IDB brake controller.

The brake system conforms to R13H global braking specification failure condition performance requirements and Society of Automotive Engineers (SAE) J 3016 driving automation standards.

The vehicle is configured with level 2 (L2) driving automation capabilities.

The brake controller assembly further comprises a redundant controller architecture comprising a first electronic control unit (ECU) and a second ECU, and only the first ECU among the first ECU and the second ECU is connected to the backup power source.

The brake controller assembly further comprises a switching circuit that is configured to switch the first ECU from the primary power source to the backup power source when the switching circuit detects that the primary power source has failed, the switching circuit being a fully analog circuit comprising one or more power transistors.

The brake system comprises a dual controller area network (CAN) support communication system comprising redundant CAN buses.

According to various embodiments of the present disclosure, a brake system for a vehicle may comprise: two first-type brakes connected to a first set of wheels of the vehicle; two second-type brakes connected to a second set of wheels of the vehicle; and a brake controller assembly configured to control the two first-type brakes and the two second-type brakes, the brake controller assembly being connected to a primary power source of the vehicle and a backup power source of the vehicle that is separate from the primary power source and is installed within the vehicle external to the brake controller assembly, wherein the brake controller assembly is configured to control the two first-type brakes and the two second-type brakes such that, in response to a failure of the primary power source of the vehicle, the two first-type brakes provide braking for the vehicle using the backup power source and a push through mechanism of the brake system, and the two second-type brakes provide parking brake application for the vehicle using solely the backup power source.

The vehicle comprises two front wheels and two rear wheels, the two first-type brakes are integrated dynamic brakes (IDBs) and the first set of wheels is the two front wheels, and the two second-type brakes are electromechanical brakes (EMBs) and the second set of wheels is the two rear wheels.

The push through mechanism is a hydraulic system of the vehicle that connects a brake pedal of the vehicle with the brake controller assembly and the two first-type brakes, and the backup power source is configured to power a brake input unit of the brake system that provides a push through input to the two first-type brakes in response to the failure of the primary power source.

The parking brake application is provided using an electromechanical parking pawl of the EMBs.

The brake controller assembly comprises an Electronic Brake Control Module (EBCM) and the EBCM is a 2-channel IDB brake controller.

The brake system conforms to R13H global braking specification failure condition performance requirements and Society of Automotive Engineers (SAE) J 3016 driving automation standards.

The vehicle is configured with level 3 (L3) and/or level 4 (L4) driving automation capabilities.

The brake controller assembly further comprises a redundant controller architecture comprising a first electronic control unit (ECU) and a second ECU, and only the first ECU among the first ECU and the second ECU is connected to the backup power source.

The brake controller assembly further comprises a switching circuit that is configured to switch the first ECU from the primary power source to the backup power source when the switching circuit detects that the primary power source has failed, the switching circuit being a fully analog circuit comprising one or more power transistors.

The brake system comprises a dual controller area network (CAN) support communication system comprising redundant CAN buses.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1A is a diagram illustrating a brake system of a vehicle according to an exemplary embodiment of the present disclosure.

FIG. 1B is a diagram illustrating a brake system of a vehicle according to an exemplary embodiment of the present disclosure.

FIG. 1C is a diagram illustrating an example brake controller assembly configuration of the brake systems of FIGS. 1A and 1B according to an exemplary embodiment of the present disclosure.

FIG. 1D is an implementation example of the brake systems of FIGS. 1A and 1B according to an exemplary embodiment of the present disclosure.

FIG. 2 is a diagram illustrating a communication system of the brake systems of FIGS. 1A and 1B according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

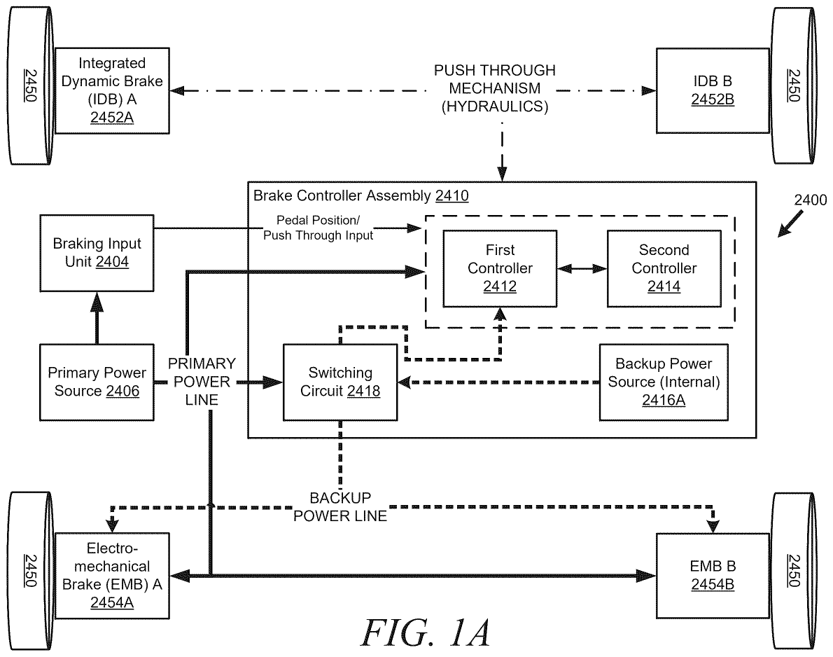

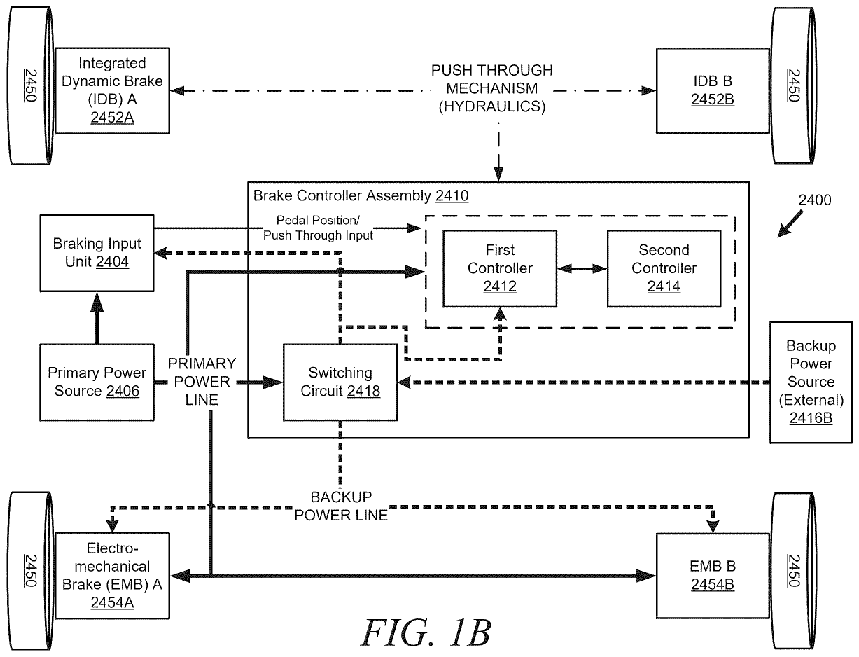

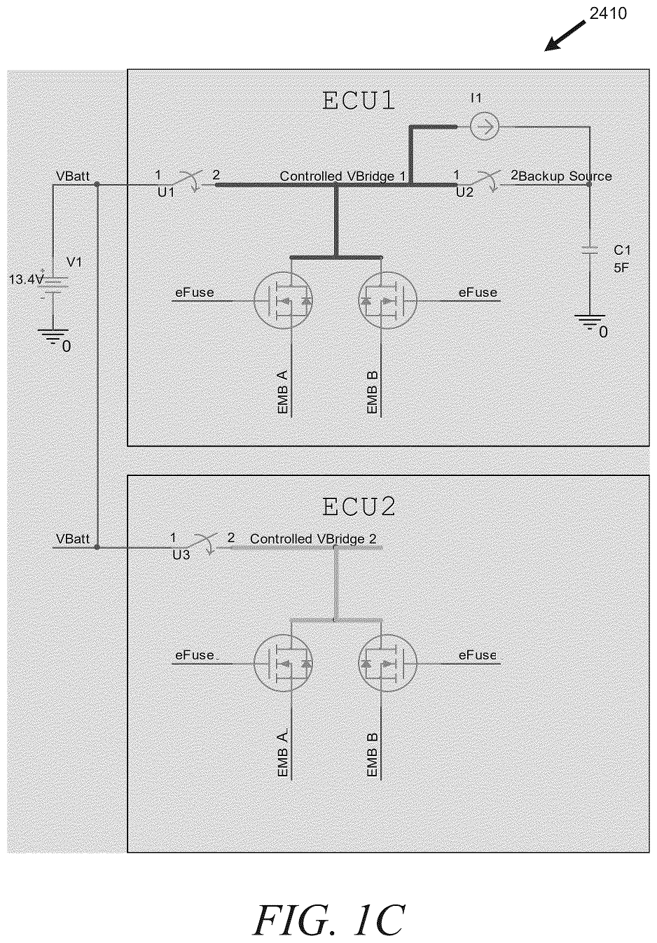

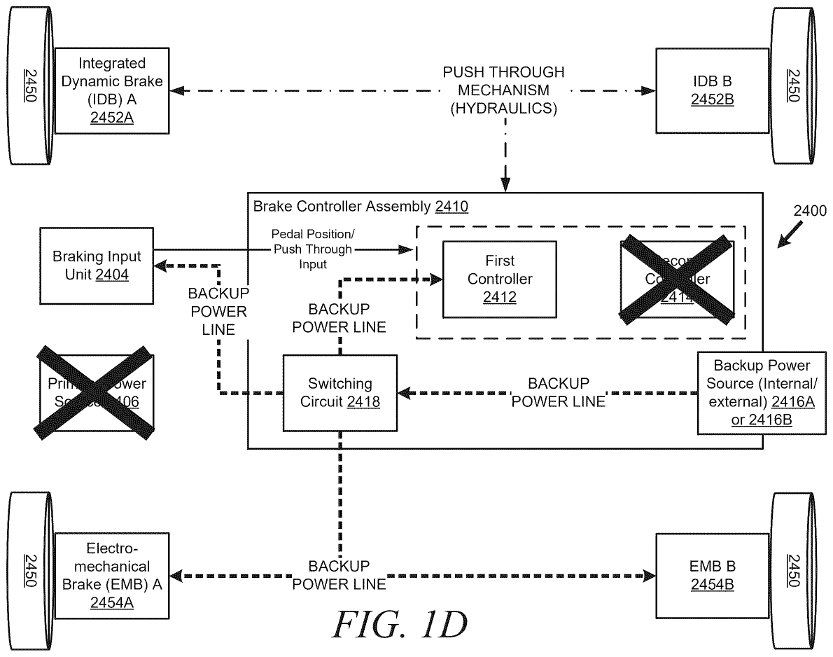

Starting with FIG. 1A, FIG. 1A shows a brake system 2400 of a vehicle (i.e., a motor vehicle) according to an exemplary embodiment of the present disclosure. In embodiments, the brake system 2400 of FIG. 1A is compatible with any type of steering systems (e.g., steer-by-wire, power steering, rack and pinion steering, recirculating ball steering, hydraulic power steering, electric power steering, manual steering, or the like). When used in a vehicle with the steer-by-wire system, the brake system 2400 of FIG. 1A may be configured a brake-by-wire brake system. Additionally, the brake system 2400 of FIG. 1A is adapted to meet all of the requirements set for a level 2 (L2) driving automation vehicle as defined under Society of Automotive Engineers (SAE) J 3016 “Taxonomy and Definitions for Terms Related to Driving Automation Systems for On-Road Motor Vehicles” definitions, standards, and/or requirements.

As shown in FIG. 1A, the brake system 2400 may have two types of brakes connected to the road wheels 2450 of a vehicle. In embodiments, a first type of brakes (also referred to herein as “first-type brakes”) may be integrated dynamic brakes (IDBs) 2452A and 2452B. The second type of brakes (also referred to herein as “second-type brakes”) may be electromechanical brakes (EMBs) 2454A and 2454B. All of the brakes (i.e., IDB A 2452A, IDB B 2452B, EMB A 2454A, and EMB B 2454B) are powered using at least a primary power source 2406 (e.g., a main battery of the vehicle, or the like) and controlled using a brake controller assembly 2410 that receives braking inputs (namely, through braking input unit 2404) from the driver and/or vehicle (e.g., in autonomous driving situations).

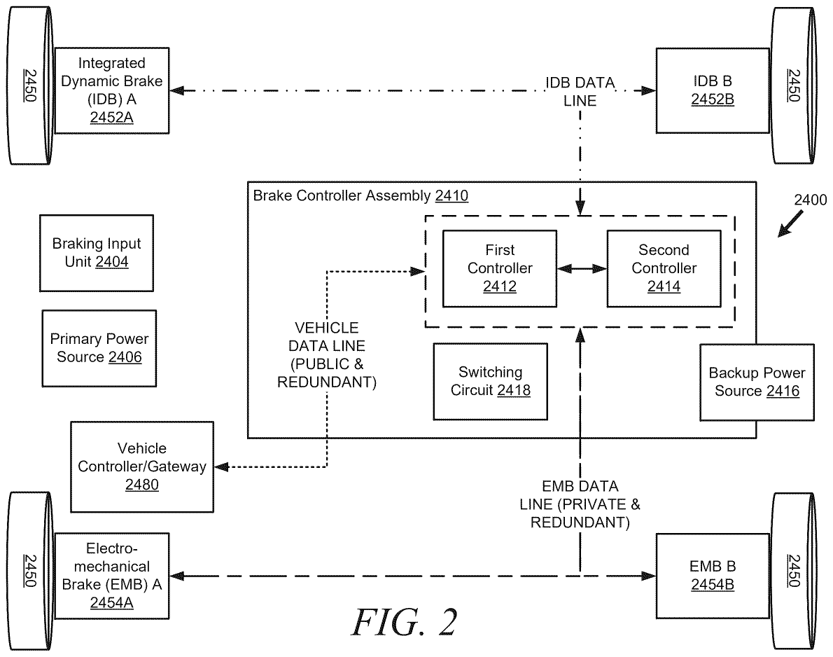

In embodiments, the IDBs (i.e., 2452A and 2542B) may be any type of IDBs with both electronic and mechanical (e.g., hydraulic, or the like) control capabilities. For example, the IDBs may be a brake system that combine traditional brake components (like master cylinder, booster, Anti-lock Braking System (ABS), and Electronic Stability Control (ESC)) into a single unit, often using electric or electro-hydraulic power. The IDBs (i.e., 2452A and 2542B) may be HL Mando's IDB2 Base integrated dynamic brakes. Each of the IDBs (i.e., 2452A and 2542B) may receive the braking inputs from the brake controller assembly 2410 via a respective data line configured to communicate signals (i.e., data signals) to and from the IDBs (i.e., 2452A and 2542B) to the brake controller; the data lines being shown and described in more detail in reference to FIG. 2. Each of the IDBs (i.e., 2452A and 2542B) may also be configured with a push through mechanism (e.g., hydraulic control, or the like) that can be utilized in case of power failure of the primary power source 2406.

In the example shown in FIG. 1A, the brake system 2400 of embodiments disclosed herein is configured to have the IDBs (i.e., 2452A and 2542B; the first-type brakes) installed on the set of front wheels (also referred to herein as “a first set of wheels”) of the vehicles.

The EMBs (i.e., 2454A and 2454B) may be any type of electromechanical brake (also referred to in the field as “electro-mechanical brake”) systems that utilizes a brake-by-wire system that uses electric motors at each wheel to apply braking force while completely replacing hydraulic fluid and mechanical linkages. The EMBs (i.e., 2454A and 2454B) may be configured to include parking brakes, and may be configured to receive power (i.e., via the power lines shown in FIG. 1A) from the power source 2406. Other types of brakes that are similar in nature to EMBs (namely, that do not include any hydraulic fluid and mechanical linkages) may also be used as the second-type brakes without departing from the scope of embodiments disclosed herein.

In embodiments, because of the lack of hydraulic fluid and mechanical linkages, should the primary power source 2406 fail, the EMBs (i.e., 2454A and 2454B) will also fail and become non-operational such that neither of the EMBs (i.e., 2454A and 2454B) will be able to provide any braking capabilities for a braking operation of the vehicle. Said another way, if either one of the EMBs (i.e., 2454A and 2454B) lose power, the EMB that lost power will not be able to provide any braking capabilities for the vehicle.

Conversely, because of the push through mechanism (e.g., hydraulic control, or the like) available to the IDBs (i.e., 2452A and 2542B), both of the IDBs (i.e., 2452A and 2542B) will still be functional (i.e., operational) and still be able to provide braking capabilities for the vehicle even if power is lost to these IDBs (i.e., 2452A and 2542B). Said another way, should the primary power source 2406 fail, the IDBs (i.e., 2452A and 2542B) will still be able to use the push through mechanism to provide braking capabilities for the vehicle. In embodiments, the push through mechanism may be configured as a hydraulic system and may be activated upon depressing of the brake pedal by a driver (and/or automatically by the vehicle in an autonomous vehicle setting). Other types of push through mechanisms similar in nature to the hydraulic system/hydraulic control may also be used without departing from the scope of embodiments disclosed herein. Other types of brakes that are similar in nature to IDBs (namely, that include a push through mechanism that allows the brakes to still be operational and provide braking capabilities even during a loss of electrical power to the brakes) may also be used as the first-type brakes without departing from the scope of embodiments disclosed herein.

Each of the EMBs (i.e., 2454A and 2454B) may also communicate with the brake controller assembly 2410 (e.g., to receive the braking inputs, to provide operational data to the brake controller assembly 2410, or the like) using one or more communication channels established between each EMB (i.e., 2454A and 2454B) and the brake controller assembly 2410. The communication system and communication channels of the brake system 2400 are described in more detail in reference to FIG. 2.

In the example shown in FIG. 1A, the brake system 2400 of embodiments disclosed herein is configured to have the EMBs (i.e., 2454A and 2454B; the second-type brakes) installed on the set of rear wheels (also referred to herein as “a second set of wheels”) of the vehicles.

Such a configuration of the brake system 2400 of embodiments disclosed herein not only advantageously allows the brake system 2400 to be powered using only one power source (e.g., the main battery of the vehicle, or the like) but also provides a “fail safe” state where at least two brakes (namely, the two first-type brakes installed on the set of front wheels) to still provide sufficient braking capabilities for the vehicle should the vehicle lose power (i.e., should power be lost to the EMBs (i.e., 2454A, 2454B) installed as a the second-type brakes on the set of rear wheels).

Thus, even with such a configuration of a brake system 2400 that includes two different brake types (namely, a first type with a push through mechanism that can still operate when the brakes lose electrical power and a second type without the push through mechanism that will become fully in-operational/non-operational when the brakes lose electrical power), the brake system can still advantageously meet (i.e., conform to) R13H global braking specification failure condition performance requirements. Additionally, such a configuration of a brake system 2400 that includes these two types of brakes advantageously allows for the entire brake system 2400 to be powered using only one (i.e., a single) power source (namely, primary power source 2406) that is used by all other components of the vehicle (i.e., all other components installed within the vehicle besides the components of the brake system 2400) while still being able to meet R13H global braking specification failure condition performance requirements for vehicle braking and safety performance. Thus, the use of two different types of brakes is not just a mere substitution of parts (e.g., brake types) but instead a carefully planned and meticulously designed aspect (i.e., a criticality) of embodiments disclosed herein. Such use of two different types of brakes is also an improvement over conventional systems that require all brakes of a vehicle to be a same brake type (e.g., either all IDBs or all EMBs on all of the wheels of the vehicle).

In embodiments, the brake controller assembly 2410 may be configured using an Electronic Brake Control Module (EBCM). More specifically, the EBCM may be configured as a 2-channel (2-CH) IDB EBCM. The brake controller assembly 2410 may receive any type of braking operation and inputs as the braking inputs from the braking input unit 2404. For example, the braking operation and inputs may include, but are not limited to: pedal position of the brake pedal, vehicle speed, push through inputs, or the like. In embodiments, the brake controller assembly 2410 may be a separate electrical control unit (ECU) from the other ECUs (e.g., a main chassis controller (not shown in the figures), or the like) of the motor vehicle. More specifically, the brake controller assembly 2410 may be one among multiple ECUs in the vehicle that is configured solely for controlling the brake system 2400 and is separate from a main controller/computer (e.g., a chassis controller, or the like) of the vehicle.

In embodiments, the brake controller assembly 2410 may include a first controller 2412, a second controller 2414, a switching circuit 2418, and a backup power source 2416. Each of the first and second controllers 2412 and 2414 can be configured as, for example, but not limited to: a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components.

In one example of embodiments disclosed herein, the first controller 2412 may be configured to act as a primary ECU that controls all of the brakes (i.e., IDB A 2452A, IDB B 2452B, EMB A 2454A, and EMB B 2454B) while the second controller may be configured as a backup (e.g., redundant) ECU that kicks in should the primary ECU fail (namely, forming a redundant controller architecture for the brake system 2400).

The switching circuit 2418 may be configured to detect failure within the primary power source 2406 (e.g., a main vehicle battery) of the vehicle in order to switch a connection between certain components (e.g., some of the EMB A 2454A, EMB B 2454B, the first controller 2412, or the like) of the brake system 2400 between the primary power source 2406 to a backup power source (e.g., internal backup power source 2416A of the brake controller assembly 2410). Said another way, when the primary power source 2406 is working, the switching circuit 2418 connects the components of the brake system 2400 with the primary power source 2406. When the primary power source 2406 fails, the switching circuit 2418 connects the components of the brake system 2400 with the internal backup power source 2416A.

In embodiments, the switching circuit 2418 may be implemented using purely analog components. For example, the switching circuit 2418 may be configured using a combination of physical switches and transistors (e.g., power Metal-Oxide-Semiconductor Field-Effect Transistors (MOSFETs), bipolar junction transistors (BJTs), or the like). Having the switching circuit 2418 be configured in a purely analog manner advantageously increases a detection and response time of the power failure (of the primary power source 2406) as compared to using a digital and analog hybrid (e.g., using microcontrollers to detect and process power levels, current, or the like) configuration.

In embodiments, the switching circuit 2418 may also be referred to as a “Power OR” circuit (as will be described in more detail below in reference to FIG. 1C). In one example of embodiments disclosed herein, the switching circuit 2418 may be implemented as part of the first controller 2412 (e.g., installed on a printed circuit board (PCB), or the like, of the first controller 2412). In another example, the switching circuit 2418 may be implemented as its own individual component (or combination of components on its own PCB or the like) separate from the other components (i.e., the first controller 2412, the second controller 2414, the internal backup power source 2416A) of the brake controller assembly 2410.

The internal backup power source 2416A may be implemented as a super capacitor or as a lithium rechargeable battery. Each of these example components may be charged up (or hold a charge) that is predetermined by a manufacturer of the brake system 2400 (and/or the vehicle) as being necessary for being able to provide one complete full stop (i.e., one complete full brake) of the vehicle while also having enough charge (e.g., electrical power) to set at least one of the parking brakes (also referred to herein as “park brakes”) of the EMBs 2454A and 2454B (namely, one of the parking brakes of an EMB installed on a rear wheel of the vehicle).

In one example, assume that a power of at least 200 Joules (J) is required for a 0.4G deceleration for 5 seconds from 70 kilometers per hour to a fully stopped position. Using such conditions while also assuming a capacitor charging capability of 16 volts with a current limited charging circuit, the minimum required capacitance would be 2 farads (F) with a final voltage at 7 volts on the bulk capacitance. Additionally, about 1.8F would be required for each additional stopping event. Other constraints that are considered here include: a 40 amperage (40A) peak; enough energy to perform at least one secondary brake apply and EMB parking brake apply maneuver; and a 10+ year lifetime for the backup power source 2416. As a result of such constraints and conditions, if a super capacitor is used as the backup power source 2416, the super capacitor may have the following properties: 6s2p provides 5F@18V rating; 2F required with a starting voltage of 16V on capacitors; 12 mm d*25 mm h*12 pieces; or the like. If a lithium rechargeable battery is used, the lithium rechargeable battery may have the properties of: 5 mAh battery; or the like. Both the super capacitor and the lithium rechargeable battery may be kept charged using a charging circuit (not shown) that receives power from the primary power source 2406.

In embodiments, although not shown in FIG. 1A, the brake controller assembly 2410 may include an energy storage health monitor unit and/or circuit (e.g., as part of first controller 2412, separate from first controller 2412, or the like) that monitors a health and voltage charge of the internal backup power source 2416A (e.g., the super capacitor and the lithium rechargeable battery). This advantageously ensures that the brake controller assembly 2410 (and a vehicle chassis controller or the like that communicates with the brake controller assembly) is always aware of the health and capabilities of the internal backup power source 2416A. For example, should the energy storage health monitor unit and/or circuit detect that the internal backup power source 2416A is no longer holding a charge (or not holding enough of a charge), the brake controller assembly 2410 (and/or the chassis controller of the vehicle) may issue a warning (e.g., to the driver, the manufacturer, or the like) to have the internal backup power source 2416A checked on and/or replaced.

In embodiments, the brake system 2400 may also include a braking input unit 2404 and the primary power source 2406. As discussed, the primary power source 2406 may be the main battery of the vehicle. The braking input unit 2404 may include at least one or more sensors (e.g., a pedal sensor, or the like) that is able to provide vehicle braking operation information (e.g., pedal position, vehicle speed, or the like) to the first and second controllers 2412 and 2414 of the brake controller assembly 2410. The first and second controllers 2412 and 2414 may then use (e.g., process) such vehicle braking operation information in order to operate one or more of the brakes (i.e., IDB A 2452A, IDB B 2452B, EMB A 2454A, and EMB B 2454B). The braking input unit 2404 may also provide the push through input(s) for the push through mechanism (e.g., hydraulic mechanism) of the IDBs 2452A and 2452B.

As additionally shown in FIG. 1A, all of the EMBs 2454A and 2454B may be connected to (e.g., via the primary power lines shown in FIG. 1A) and receive power from the primary power source 2406. The primary power source 2406 may also provide power to at least the braking input unit 2404, the first controller 2412, the second controller 2414, the two IDBs 2452A and 2452B, and may be connected to the switching circuit 2418. Said another way, when the primary power source 2406 is operational (i.e., has not failed), all of these components are powered by the primary power source 2406.

As further shown in the example of FIG. 1A, the switching circuit 2418 connects the first controller 2412 and both EMBs 2454A and 2454B to the internal backup power source 2416A. The second controller 2414 is not connected to the internal backup power source 2416A. Said another way, should the primary power source 2406 fail, the first controller 2412 and both EMBs 2454A and 2454B will be switched (by the switching circuit 2418 upon detection of such failure) to receive power from the internal backup power source 2416A (e.g., via the backup power lines shown in FIG. 1A). This advantageously ensures, when the primary power source 2406 has failed, a secondary brake apply and EMB parking brake apply maneuver that still meets (i.e., conforms) to international braking safety standards (e.g., the ECE R13H braking specifications, or the like). This will be discussed in more detail below in refernce to the implementation example shown in reference to FIG. 1D.

Having the internal backup power source 2416A for the EMBs 2454A and 2454B also allows advantageously allows the brake system 2400 to be configured without any mechanical (namely, purely mechanical) parking pawl mechanisms (e.g., in the IDBs 2452A and 2452B or in the EMBs 2454A and 2454B). In particular, because the internal backup power source 2416A can be sized to store enough power to allow at least one (or both) of the EMBs 2454A and 2454B to set their respective parking brake (e.g., an electromechanical parking pawl), a purely mechanical parking pawl mechanism is not needed for the brake system 2400.

Turning now to FIG. 1B, FIG. 1B shows another example of the brake system 2400 of a vehicle (i.e., a motor vehicle) according to an exemplary embodiment of the present disclosure. In the example shown in FIG. 1B, the brake system 2400 of embodiments herein may have all of the same components as the brake system 2400 of FIG. 1A except for the internal backup power source 2416A shown in FIG. 1A. More specifically, instead of having the internal backup power source 2416A, the example brake system 2400 of FIG. 1B includes an external backup power source 2416B. The external backup power source 2416B may separate from and be disposed (i.e., positioned, installed, etc.) external to the brake controller assembly 2410, and may be configured to be a backup battery of the vehicle (i.e., a backup to the primary battery).

Additionally, as shown in the example of FIG. 1B, the switching circuit 2418 connects the external backup power source 2416B to the braking input unit 2404. In the example shown in FIG. 1A, the switching circuit 2418 may also connect the internal backup power source 2416A to the braking input unit 2404 (although this is not necessary for a level 2 driving automation vehicle). In embodiments, the example brake system 2400 of FIG. 1B may not have a separate internal backup power source 2416A within the brake controller assembly 2410. Additionally, the example brake system 2400 of FIG. 1B is adapted to meet all of the requirements set for a level 3 (L3) and/or level 4 (L4) driving automation vehicle as defined under Society of Automotive Engineers (SAE) J 3016 “Taxonomy and Definitions for Terms Related to Driving Automation Systems for On-Road Motor Vehicles” definitions, standards, and/or requirements.

In embodiments and depending on whether the driving automation level of the vehicle, the brake controller assembly 2410 may include a partial or complete electronics package (e.g., a conventional and/or typical electronics package that comes with IDB EBCMs) for controlling the IDBs 2452A and 2452B. For example, a brake controller assembly 2410 for a level 2 (L2) driving automation vehicle may include only a partial electronics package where an inverter circuit between the second controller 2414 and a motor controlling the IDBs 2452A and 2452B is optional (e.g., based on manufacturer and/or vehicle owner preferences and/or needs). A brake controller assembly 2410 for a level 3 (L3) and/or level (L4) driving automation vehicle, however, may include a complete electronics package (e.g., both controllers 2412 and 2414 will be connected to the motor controlling the IDBs 2452A and 2452B via all conventional and/or typical electronic components that comes with IDB EBCMs).

Turning now to FIG. 1C, FIG. 1C shows is a diagram illustrating an example brake controller assembly configuration of the brake system 2400 of FIGS. 1A and 1B according to an exemplary embodiment of the present disclosure. The example shown in FIG. 1C should not be used to limit embodiments disclosed herein to any one particular configuration and is only presented as one non-limiting example configuration in which the brake controller assembly 2410 can be implemented.

As shown in the example of FIG. 1C, each controller (i.e., the first controller 2412 as ECU 1 and the second controller 2414 as ECU 2) may be connected to both EMBs 2454A and 2454B. Each controller may also include any number of electrical fuses (eFuses) that protect the EMBs 2454A and 2454B from current surges or the like.

As further shown in the example of FIG. 1C, the switching circuit 2418 (implemented as controlled VBridge 1 and Controlled VBridge 2 in FIG. 1C) may prevent complete loss of braking by allowing at least ECU 1 to be reconnected to (i.e., switched to) the backup source (i.e., backup power source 2416) from VBatt (i.e., the primary power source 2406). In particular, the switching circuit 2418 may be implemented using a combination of power MOSFETs that are used to OR the two sources (i.e., VBatt and Backup Srouce) together. Upon loss of VBatt, switch U1 will open while switch U2 will close, connecting the Backup Source (e.g., the internal backup power source 2416A of FIG. 1A and/or the external backup power source 2416B of FIG. 1B) to the two EMBs 2454A and 2454B connected to and controlled by ECU 1. In this example, switch U2 will remain closed during standard operation (i.e., when VBatt has not failed) and only be turned on when VBatt has failed. Drivers for the switches (e.g., U1, U2, U3) may also contain reverse battery and/or over-temperature protection mechanisms.

Turning now to FIG. 1D, FIG. 1D is an implementation example of the brake systems 2400 of FIGS. 1A and 1B according to an exemplary embodiment of the present disclosure. More specifically, FIG. 1D shows a state where the primary power source 2406 has failed, as marked by a X over the diagram for primary power source 2406.

In such a state where the primary power source 2406 has failed (e.g., due to a power failure or the like), the second controller 2414 loses power completely and becomes fully non-operational (i.e., fully incapable of providing any functions and/or capabilities these components were designed to provide). The two EMBs 2454A and 2454B also lose power temporarily. In particular, the switching circuit 2418 has detected the failure of the primary power source 2406 and has now switched the two EMBs 2454A and 2454B (and one or more other components of brake system 2400) to instead receive power from a backup power source (i.e., internal backup power source 2416A or external backup power source 2416B depending on the brake system).

In a level 2 (L2) driving automation vehicle (namely, using the example brake system 2400 of FIG. 1A), at least the first controller 2412 (namely, that receives the pedal sensing), and the two EMBs 2454A and 2454B are now powered by the internal backup power source 2416A. The braking input unit 2404 (namely, that provides pedal sensing to the brake controller assembly 2410) may also optionally be powered by the internal backup power source 2416A.

In a level 3 (L3) and/or level 4 (L4) driving automation vehicle (namely, using the example brake system 2400 of FIG. 1B), all of the first controller 2412, the two EMBs 2454A and 2454B, and the braking input unit 2404 are now powered by the external backup power source 2416B.

In all levels of driving automation vehicles (namely, all levels L2-L4), while the primary power source 2406 remains in the failure state, the push through mechanism of the IDBs 2452A and 2452B are triggered (e.g., from the first controller 2412 receiving the push through input from the braking input unit 2404 manually via a human driver and/or automatically through the braking input unit 2404 itself (e.g., being controlled by the chassis controller of the vehicle, or the like)) to cause the IDBs 2452A and 2452B to perform braking (e.g., a braking operation) for the vehicle using the push through mechanism (e.g., through hydraulic braking, or the like). While the IDBs 2452A and 2452B are performing braking using the push through mechanism, the EMBs 2454A and 2454B may be powered by the internal backup power source (namely, whichever of internal backup power source 2416A or external backup power source 2416B is applicable) to provide one parking brake apply maneuver (i.e., set a parking brake of one or both of the EMBs 2454A and 2454B).

In embodiments, the EMBs 2454A and 2454B may also be powered (namely, whichever of internal backup power source 2416A or external backup power source 2416B is applicable, and only if the internal backup power source 2416A is sized for such an operation) to also apply braking (along with the IDBs 2452A and 2452B) for the vehicle.

As a result, even with such configurations of a brake system 2400 (as shown in FIGS. 1A and 1B) that include two different brake types (namely, a first type with a push through mechanism that can still operate when the brakes lose electrical power and a second type without the push through mechanism that will become fully in-operational/non-operational when the brakes lose electrical power), the brake system can still advantageously meet (i.e., conform to) not only thee R13H global braking specification failure condition performance requirements but also the Society of Automotive Engineers (SAE) J 3016 “Taxonomy and Definitions for Terms Related to Driving Automation Systems for On-Road Motor Vehicles” definitions, standards, and/or requirements.

FIG. 2 is a diagram illustrating a communication system of the brake systems of FIGS. 1A and 1B according to an exemplary embodiment of the present disclosure. As discussed in FIG. 1A, each of the IDBs 2452A and 2452B may have respective data lines (e.g., the IDB DATA LINE shown in FIG. 2) that allow the IDBs 2452A and 2452B to receive information (e.g., the braking inputs, pedal information, or the like) from and provide information (e.g., IDB status data, or the like) to the brake controller assembly 2410 (namely, with each of the first controller 2412 and/or the second controller 2414).

Additionally, as shown in FIG. 2, the vehicle may include a vehicle controller/gateway 2480 (e.g., associated to the main/chassis controller of the vehicle) that may be in communication (e.g., via vehicle data line shown in FIG. 2) with the brake controller assembly 2410 (namely, with each of the first controller 2412 and/or the second controller 2414). The EMBs 2454A and 2454B may also be in communication (e.g., via EMB data line shown in FIG. 2) with the brake controller assembly 2410 (namely, with each of the first controller 2412 and/or the second controller 2414).

In embodiments, the vehicle data line and the EMB data line may be configured using controller area network (CAN) bus/channels (and/or the Ethernet). The vehicle data line(s) may be configured as public CAN(s) while the EMB data line(s) may be configured as private CAN(s). Each of the vehicle data line(s) and the EMB data line(s) may also be redundant. More specifically, there may be two separate public CAN vehicle data lines; one connecting the vehicle controller/gateway 2480 to the first controller 2412 and the other separately connecting the vehicle controller/gateway 2480 to the second controller 2412. Similarly, there may be two separate sets of private CAN EMB data line(s); one set connecting both EMBs 2454A and 2454B to the first controller 2412 and the other set separately connecting both EMBs 2454A and 2454B to the second controller 2414.

Such a configuration in FIG. 2 forms a dual controller area network (CAN) support communication system comprising redundant CAN buses for the brake system 2400. As a result, upon failure of one of the two controllers 2412 or 2414 (e.g., when second controller 2414 loses power due to failure of the primary power source 2416, or the like), the first controller 2412 can still separately and individually maintain CAN functions with both the EMBs 2454A and 2454B and/or with the vehicle controller/gateway 2480 (which may have its own redundant/backup power source separate from the backup power source 2416A or 2416B of the brake system 2400).

Although the example embodiments have been described in detail, it should be understood that various changes, substitutions and alterations can be made herein without departing from the spirit and scope of the application as defined by the appended claims.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A brake system for a vehicle, the brake system comprising:
two first-type brakes connected to a first set of wheels of the vehicle;
two second-type brakes connected to a second set of wheels of the vehicle; and
a brake controller assembly configured to control the two first-type brakes and the two second-type brakes, the brake controller assembly comprising a backup power source separate from a primary power source of the vehicle and provided within the brake controller assembly,
wherein the brake controller assembly is configured to control the two first-type brakes and the two second-type brakes such that, in response to a failure of the primary power source of the vehicle, the two first-type brakes provide braking for the vehicle without using the backup power source and the two second-type brakes provide parking brake application for the vehicle using the backup power source.

2. The brake system of claim 1, wherein the vehicle comprises two front wheels and two rear wheels, the two first-type brakes are integrated dynamic brakes (IDBs) and the first set of wheels is the two front wheels, and the two second-type brakes are electromechanical brakes (EMBs) and the second set of wheels is the two rear wheels.

3. The brake system of claim 2, wherein the brake controller assembly is configured to control the two first-type brakes such that, in response to the failure of the primary power source of the vehicle, the braking of the vehicle is provided solely by the two first-type brakes using a hydraulic system of the vehicle that connects a brake pedal of the vehicle with the brake controller assembly and the two first-type brakes.

4. The brake system of claim 2, wherein the parking brake application is provided using an electromechanical parking pawl of the EMBs.

5. The brake system of claim 2, wherein the brake controller assembly comprises an Electronic Brake Control Module (EBCM) and the EBCM is a 2-channel IDB brake controller.

6. The brake system of claim 5, wherein the brake system conforms to R13H global braking specification failure condition performance requirements and Society of Automotive Engineers (SAE) J 3016 driving automation standards.

7. The brake system of claim 6, wherein the vehicle is configured with level 2 (L2) driving automation capabilities.

8. The brake system of claim 2, wherein the brake controller assembly further comprises a redundant controller architecture comprising a first electronic control unit (ECU) and a second ECU, and only the first ECU among the first ECU and the second ECU is connected to the backup power source.

9. The brake system of claim 8, wherein the brake controller assembly further comprises a switching circuit that is configured to switch the first ECU from the primary power source to the backup power source when the switching circuit detects that the primary power source has failed, the switching circuit being a fully analog circuit comprising one or more power transistors.

10. The brake system of claim 2, wherein the brake system comprises a dual controller area network (CAN) support communication system comprising redundant CAN buses.

11. A brake system for a vehicle, the brake system comprising:
two first-type brakes connected to a first set of wheels of the vehicle;
two second-type brakes connected to a second set of wheels of the vehicle; and
a brake controller assembly configured to control the two first-type brakes and the two second-type brakes, the brake controller assembly being connected to a primary power source of the vehicle and a backup power source of the vehicle that is separate from the primary power source and is installed within the vehicle external to the brake controller assembly,
wherein the brake controller assembly is configured to control the two first-type brakes and the two second-type brakes such that, in response to a failure of the primary power source of the vehicle, the two first-type brakes provide braking for the vehicle using the backup power source and a push through mechanism of the brake system, and the two second-type brakes provide parking brake application for the vehicle using solely the backup power source.

12. The brake system of claim 11, wherein the vehicle comprises two front wheels and two rear wheels, the two first-type brakes are integrated dynamic brakes (IDBs) and the first set of wheels is the two front wheels, and the two second-type brakes are electromechanical brakes (EMBs) and the second set of wheels is the two rear wheels.

13. The brake system of claim 12, wherein the push through mechanism is a hydraulic system of the vehicle that connects a brake pedal of the vehicle with the brake controller assembly and the two first-type brakes, and the backup power source is configured to power a brake input unit of the brake system that provides a push through input to the two first-type brakes in response to the failure of the primary power source.

14. The brake system of claim 12, wherein the parking brake application is provided using an electromechanical parking pawl of the EMBs.

15. The brake system of claim 12, wherein the brake controller assembly comprises an Electronic Brake Control Module (EBCM) and the EBCM is a 2-channel IDB brake controller.

16. The brake system of claim 15, wherein the brake system conforms to R13H global braking specification failure condition performance requirements and Society of Automotive Engineers (SAE) J 3016 driving automation standards.

17. The brake system of claim 16, wherein the vehicle is configured with level 3 (L3) and/or level 4 (L4) driving automation capabilities.

18. The brake system of claim 12, wherein the brake controller assembly further comprises a redundant controller architecture comprising a first electronic control unit (ECU) and a second ECU, and only the first ECU among the first ECU and the second ECU is connected to the backup power source.

19. The brake system of claim 18, wherein the brake controller assembly further comprises a switching circuit that is configured to switch the first ECU from the primary power source to the backup power source when the switching circuit detects that the primary power source has failed, the switching circuit being a fully analog circuit comprising one or more power transistors.

20. The brake system of claim 12, wherein the brake system comprises a dual controller area network (CAN) support communication system comprising redundant CAN buses.
